(19) United States
(12) Patent Application Publication
(10) Pub. No.: US 2017/0235252 A1
(43) Pub. Date: Aug. 17, 2017

(54) DEVELOPING APPARATUS

(71) Applicant: CANON KABUSHIKI KAISHA, Tokyo (JP)

(72) Inventor: Yuta Okuyama, Kashiwa-shi (JP)

(21) Appl. No.: 15/429,456

(22) Filed: Feb. 10, 2017

(30) Foreign Application Priority Data
Feb. 12, 2016 (JP) 2016-025109

(51) Int. Cl. G03G 15/08

(52) U.S. Cl. CPC G03G 15/0891

(57) ABSTRACT

A developing device includes a developing sleeve; a first chamber for supplying two-component developer; a second chamber for collecting the developer; a first screw for feeding the developer in the first chamber in a first direction; a second screw for feeding the developer in the first chamber in a second direction opposite the first direction; a partition between the first and second chambers and including a first opening for feeding the developer from the second chamber to the first chamber, and a second opening for feeding the developer from the first chamber to the second chamber; and a toner content sensor. The toner sensor detects the developer in a region which is in the first opening with respect to an axis of the sleeve and which is between a rotation axis of the first screw and a rotation axis of the second screw with respect to a perpendicular direction.

### FIELD OF THE INVENTION AND RELATED ART

The present invention relates to a developing apparatus (device) which is suitable for an image forming apparatus such as a printing machine, a copying machine, a facsimileing machine, a multifunction machine capable of performing two or more functions of the preceding machines, etc., which uses electrophotographic technologies.

A developing device employed by an image forming apparatus such as a printing machine, a copying machine, a facsimileing machine, a multifunction machine, etc., which uses electrophotographic technologies, uses two-component developer (which hereafter will be referred to simply as “developer”) made up of nonmagnetic toner and magnetic carrier. The toner in two-component developer is consumed as two-component developer is used for development. Thus, as a developing device is used for development, the developer in the developer container of the developing device changes in toner density. Thus, unless the developer in the developing device in an image forming apparatus is kept in a preset range in toner density, the image forming apparatus outputs unsatisfactory images. There have been known developing devices designed to replenish their developer container with a fresh supply of toner by an amount proportional to the toner density of the developer in the developer container, so that the toner density of the developer in the developer container remains in a preset range.

In recent years, it has become a common practice to use an inductance sensor to determine the toner density of developer. An inductance sensor uses a coil to detect the inductance of developer to determine the toner density of the developer. Thus, if the developing device which uses an inductance sensor is structured so that a body of toner on the inductance detection surface of the sensor is slow to be replaced, that is, if the developer in the developer container is slow in movement, it is difficult for the sensor to accurately detect the inductance of the developer to determine the toner density of the developer in the developer container. Thus, there has been proposed a developing device designed so that the detection surface of its inductance sensor is protrusive toward the stirring screw in the developer container, and also, that the portion of the stirring screw, which corresponds in position to the detection surface, is smaller in the radius of the stirring screw shaft than the rest of the stirring screw, in order to ensure that the developer in the developer container does not become stagnant on the detection surface (Japanese-Laid-open Patent Application No. H05-323794). There has also been proposed a developing device designed so that the portion of the stirring screw shaft, which corresponds in position to the detection surface, is provided with ribs for preventing the developer from becoming stagnant on the detection surface (Japanese Laid-open Patent Application No. H09-269638).

By the way, simply designing a developing device so that the developer in the developer container moves on the detection surface at a higher speed than in a conventional developing device is insufficient to ensure that the sensor accurately detects the developer inductance to accurately determine the toner density of the developer in the developer container. Thus, it is desired that a developing device is designed so that the body of developer on the detection surface remains stable in bulk density within a preset range, in addition to designing the device in the above-described manner. However, in the case of the developing devices disclosed in the abovementioned Japanese Laid-open Patent Applications Nos. H05-323794 and H09-269638, it is possible that the body of developer on the detection surface will be likely to be affected by the rotation of the stirring screw, and therefore, the body of developer on the detection surface will be unlikely to remain stable in bulk density. Therefore, these developing devices are unsatisfactory in the level of accuracy at which the toner density of the developer in the developer container is determined based on the output of the sensor.

### SUMMARY OF THE INVENTION

Thus, the primary object of the present invention is to provide a developing device which is significantly higher in the accuracy with which the toner density of the developer in its developer container is determined based on the output of its toner density sensor, than any conventional developing device.

According to an aspect of the present invention, there is provided a developing device comprising a rotatable developer carrying member configured to carry a developer containing toner and carrier; a first chamber provided opposed to said developer carrying member to supply the developer to said developer carrying member; a second chamber provided opposed to said developer carrying member to collect the developer from said developer carrying member; a first feeding screw configured to feed the developer in said first chamber in a first direction; a second feeding screw configured to feed the developer in said first chamber in a second direction which is opposite the first direction; a partition configured to partition between said first chamber and said second chamber and including a first communicating portion configured to feed the developer from said second chamber to said first chamber, and a second communicating portion configured to feed the developer from said first chamber to said second chamber; and a toner content sensor configured to detect a toner content of the developer; wherein said toner content sensor is disposed so as to detect the developer in a region which is in said first communicating portion with respect to rotational axis direction of said developer carrying member and which is between a rotation axis of said first feeding screw and a rotation axis of said second feeding screw with respect to a direction perpendicular to the rotational axis direction.

Further features of the present invention will become apparent from the following description of exemplary embodiments with reference to the attached drawings.

### BRIEF DESCRIPTION OF THE DRAWINGS

FIG. 1 is a schematic sectional view of a typical image forming apparatus which is compatible with a developing device in accordance with the present invention. It shows the general structure of the apparatus.

FIG. 2 is a block diagram of the control system of the apparatus (shown in FIG. 1), which is for controlling the operation for replenishing the developing device of the apparatus with toner.

FIG. 3 is a sectional view of the developing device in an embodiment of the present invention.

FIG. 4 is a sectional view of the developing device (shown in FIG. 3) at a horizontal plane which coincides with the axial line of each of the stirring screw and development screw of the developing device.

FIG. 5 is a flowchart of the control sequence for controlling the operation for replenishing the developing device with toner.

FIG. 6 is a drawing for describing the angle of repose and angle of collapse of developer.

FIG. 7 is a sectional view of a comparative developing device.

FIG. 8 is a graph which shows the difference in the amount of toner density detection error between the developing device in the embodiment of the present invention and the comparative developing device.

Parts (a), (b) and (c) of FIG. 9 are graphs which show the changes (in waveform amplitude), which occurred to the output voltage of the sensor when only one of the two screws which are different in rotational phase is rotated. More specifically, part (a) of FIG. 9 shows the changes when the rotational phase is 180°; part (b) of FIG. 9, 90°; and part (c) of FIG. 9 shows the changes when the rotational phase is 0°.

FIG. 10 is a graph which shows the changes (in waveform amplitude) which occurred to the output of the sensor when the two screws which are different in the phase of their blades are simultaneously rotated.

### DESCRIPTION OF THE EMBODIMENTS

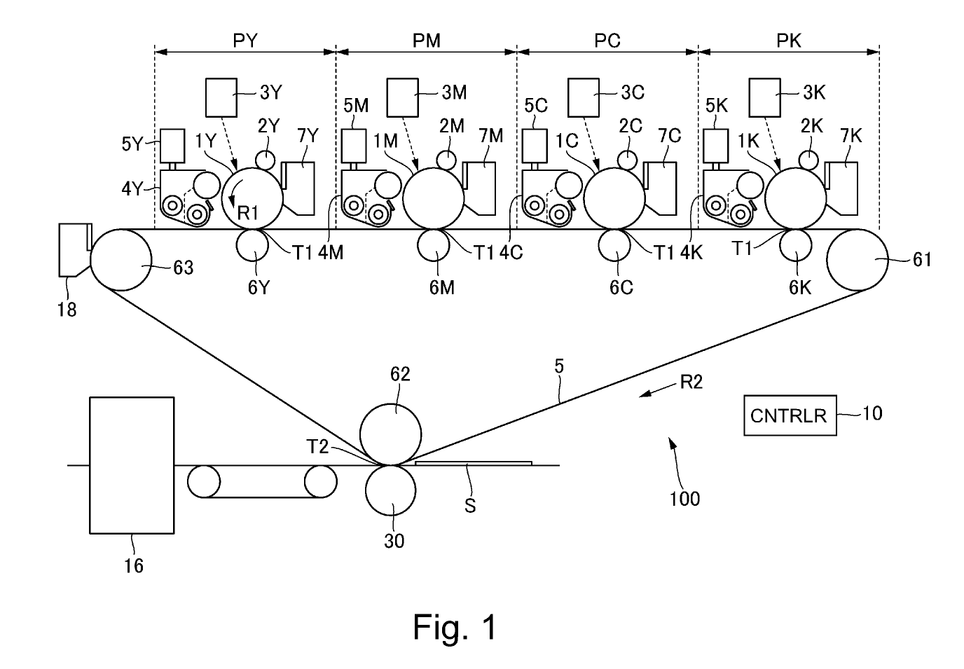

Hereafter, the first of the preferred embodiments of the present invention is described. First, referring to FIG. 1, an image forming apparatus equipped with a developing device in this embodiment is described about its structure. The image forming apparatus 100 shown in FIG. 1 is a full-color printer of the so-called tandem type, and also, of the so-called intermediary transfer type. That is, it has an intermediary transfer belt 5, and four image forming portions PY, PM, PC and PK sequentially disposed along the intermediary transfer belt 5.

### <Image Forming Apparatus>

In the image forming portion PY, a yellow toner image is formed on the photosensitive drum 1Y, and is transferred onto the intermediary transfer belt 5. In the image forming portion PM, a magenta toner image is formed on the photosensitive drum 1M, and is transferred onto the intermediary transfer belt 5. In the image forming portions PC and PK, cyan and black toner images are formed on the photosensitive drums 1C and 1K, respectively, and are transferred onto the intermediary transfer belt 5. After being transferred onto the intermediary transfer belt 5, the four toner images which are different in color are conveyed by the intermediary transfer belt 5 to the secondary transferring portion T2 (secondary transfer nip), in which they are transferred (secondary transfer) together onto a sheet S of recording medium (ordinary paper, OHP film, etc.), which was moved out of an unshown sheet feeder cassette and delivered to the secondary transferring portion T2.

The image forming portions PY, PM, PC and PK are roughly the same in structure, although they are different in the color of the toner they use (yellow, magenta, cyan and black, respectively). Thus, the suffixes Y, M, C and K which indicate the differences among the four image forming portions PY, PM, PC and PK will not be shown.

Each image forming portion P has a photosensitive drum 1 as an image bearing member. It has also a charge roller 2, an exposing device 3, a developing device 4, a transfer roller 6, and a drum cleaning device 7, which are disposed in the listed order, in a manner to surround the photosensitive drum 1. The photosensitive drum 1 is made up of a piece of aluminum cylinder, and a photosensitive layer formed on the peripheral surface of the aluminum cylinder. It is rotated in the direction indicated by an arrow mark R1 in FIG. 1, at a preset process speed.

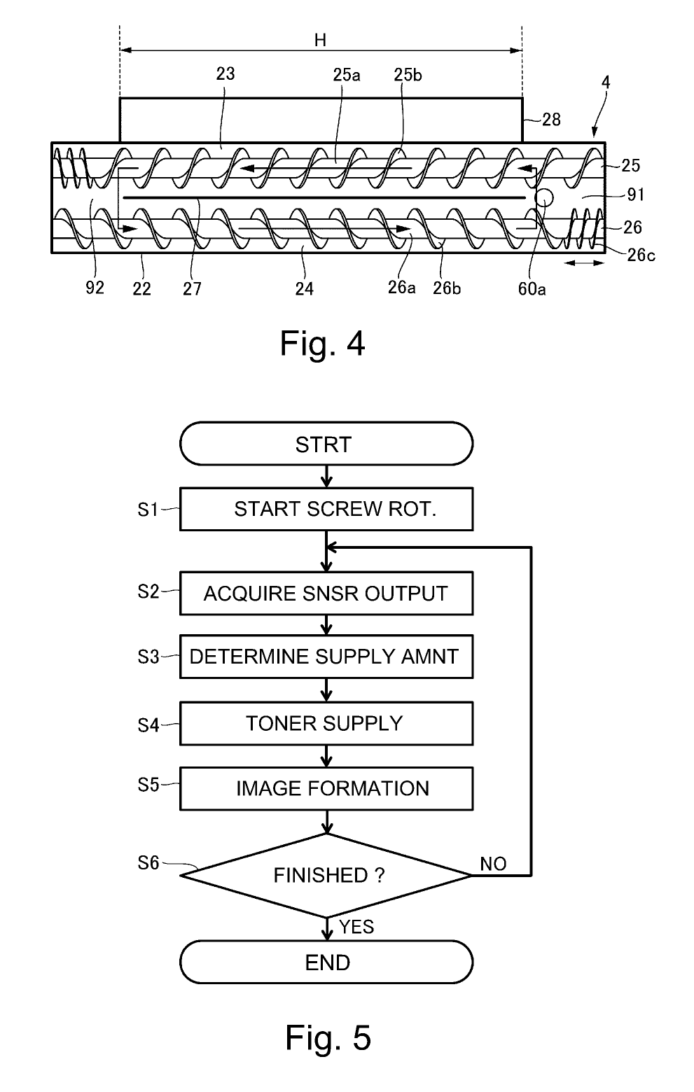

The charge roller 2 uniformly charges the peripheral surface of the photosensitive drum 1 to a preset potential level (pre-exposure level) by being placed in contact with the peripheral surface of the photosensitive drum 1 when charge voltage is being applied to the charge roller 2. The exposing device 3 writes an electrostatic image on the charged portion of the peripheral surface of the photosensitive drum 1. More specifically, a full-color image (inclusive of black-and-white image) is separated into a preset number of monochromatic images which are different in color. Then, these monochromatic images are converted into image formation data. The exposing device 3 outputs a beam of laser light while modulating (turning on or off) the beam according to the image formation data, and deflecting the beam with the use of its rotational mirror in a manner to scan the charged portion of the peripheral surface of the photosensitive drum 1, with the beam. Consequently, an electrostatic image is effected on the peripheral surface of the photosensitive drum 1. The developing device 4 develops the electrostatic image into a toner image by supplying the peripheral surface of the photosensitive drum 1 with toner. The details of the developing device 4 will be given later (FIGS. 3 and 4).

The transfer roller 6 is disposed so that it opposes the intermediary transfer belt 5 in a manner to sandwich the intermediary transfer belt 5 between itself and photosensitive drum 1, forming thereby the primary transferring portion T1 (primary transfer nip) between the photosensitive drum 1 and intermediary transfer belt 5. In the primary transferring portion T1, the primary transfer voltage is applied to the transfer roller 6 by a high voltage power source (unshown) for example, whereby the toner image is transferred (primary transfer) from the photosensitive drum 1 onto the intermediary transfer belt 5. More specifically, as the primary transfer voltage, which is opposite in polarity from the toner charge, is applied to the transfer roller 6, the toner image on the photosensitive drum 1 is adhered to the intermediary transfer belt 5 by being electrostatically attracted to the intermediary transfer belt 5. The drum cleaning device 7 removes the primary transfer residual toner, that is a small amount of toner which remains on the peripheral surface of the photosensitive drum 1 after the primary transfer, by placing its cleaning blade in contact with the peripheral surface of the photosensitive drum 1 in such a manner that as the photosensitive drum 1 is rotated, the cleaning blade scrapes the peripheral surface of the photosensitive drum 1.

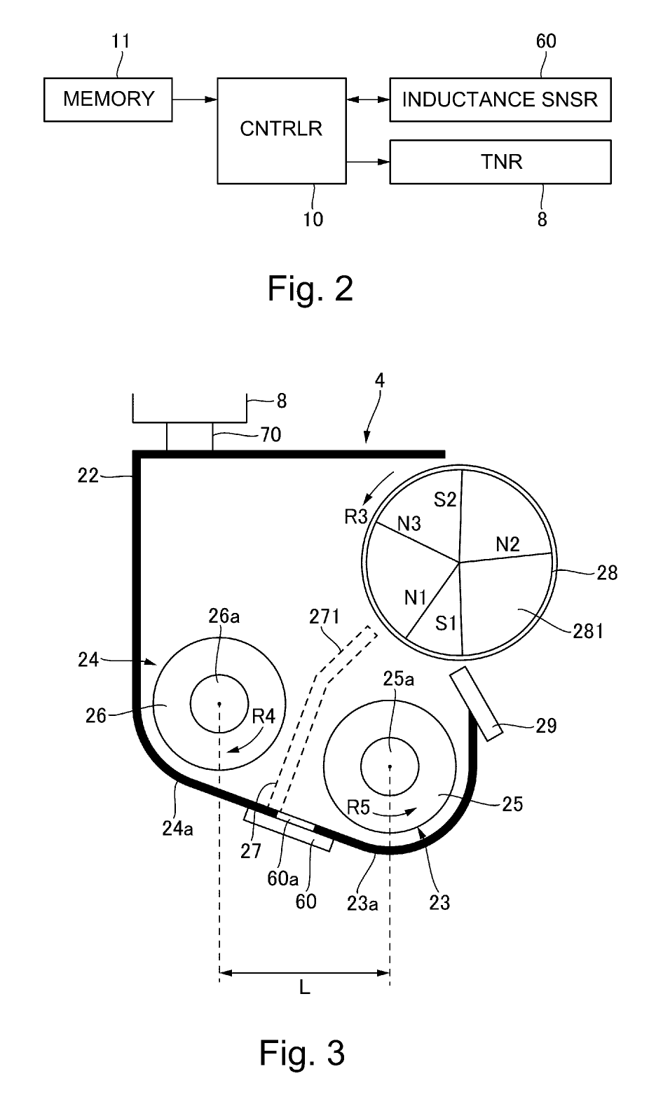

The intermediary transfer belt 5 is supported by a combination of a tension roller 61, an inward secondary transfer roller 62, a driver roller 63, etc., in a manner to bridge the adjacent two of the above listed rollers. It is driven by the driver roller 63 to be moved in the direction indicated by an arrow mark R2 in FIG. 2. The secondary transferring portion T2 is formed by the pressing of the outward secondary transfer roller 30 against the inward secondary transfer roller 62. It is a transfer nip in which a toner image is transferred onto a sheet S of recording medium. In the second transferring portion T2, a preset secondary transfer voltage is applied to the inward secondary transfer roller 62. As the transfer voltage is applied to the inward secondary transfer roller 62, a toner image (toner images) is transferred (secondary transfer) onto a sheet S of recording medium from the intermediary transfer belt 5 while the sheet S is conveyed through the secondary transferring portion T2 while remaining pinched between the intermediary transfer belt 5 and outward secondary transfer roller 30. The secondary transfer residual toner, that is, the toner which remains adhered to the intermediary transfer belt 5 after the secondary transfer, is removed by the belt cleaning device 18. More specifically, the cleaning blade of the belt cleaning device 18 is placed in contact with the intermediary transfer belt 5 in a manner to scrape the intermediary transfer belt 5 as the intermediary transfer belt 5 is moved. Thus, as the intermediary transfer belt 5 is moved in the abovementioned direction, the secondary transfer residual toner is removed by the belt cleaning device 18.

After the transfer of the four monochromatic toner images, which are different in color, onto the sheet S of recording medium, in the secondary transferring portion T2, the sheet S is conveyed to a fixing device 16, which fixes the four unfixed monochromatic toner images on the sheet S to the sheet S. More specifically, the fixing device 16 has a pair of mutually opposing rollers or belts, and a heat source (unshown) which generally is a heater. It applies heat and pressure to the sheet S and the toner images thereon, with the use of the heat source and the pair of rollers or belts, respectively. Consequently, the images are melted, and then, become permanently adhered to the sheet S as they cool down and solidify. After the fixation of the toner images to the sheet S by the fixing device 16, the sheet S is discharged from the main assembly of the image forming apparatus 100.

The toner supplying device 8 is capable of replenishing the developing device 4 with toner (which is replenishment agent, strictly speaking) by an amount equivalent to the amount by which the toner in the developer in the developing device 4 is consumed for image formation.

### <Control Portion>

In this embodiment, the image forming apparatus 100 is provided with a control portion 10. The control portion 10 is a CPU or the like, for example, which controls various operations, such as an image forming operation, for example, of the image forming apparatus 100. In this embodiment, the control portion 10 is capable of controlling the operation for replenishing the developing device 4 with toner. Next, referring to FIG. 2, the control portion 10 is described. FIG. 2 is a block diagram of the system for replenishing the developing device 4 with a fresh supply of toner. As is evident from FIG. 2, the control portion 10 is in connection to a memory 11, an inductance sensor 60 (which hereafter will be referred to simply as “sensor 60”), and the toner supplying device 8, through an unshown interface. By the way, the control portion 10 is capable of controlling each of the abovementioned other portions (FIG. 1) of the image forming apparatus 100 than those shown in FIG. 2. Here, however, the portions which are not essential to the present invention are not illustrated or described.

The memory 11 is a ROM, a RAM, a hard disk, or the like. Various programs for controlling the operation for forming an image, operation for replenishing the developing device 4 with a fresh supply of toner, and the like operations, and various data, etc., are stored in advance in the memory 11. Examples of the various data are the relationship between the results of the detection by the sensor 60 (average of voltage values detected per rotation of screw) and the toner density data (in the form of table, for example), or the like. Further, the memory 11 is capable of temporarily storing the results of the computations required of the control portion 10 to carry out various programs. The control portion 10 is capable of carrying out various programs stored in the memory 11. It controls the image forming apparatus 100 by carrying out these programs. That is, the control portion 10 is capable of controlling the various operations of the image forming apparatus 100, for example, the image forming operations carried out by the image forming portions PY-PK, primary transfer of toner images onto the intermediary transfer belt 5, secondary transfer of toner images onto a sheet S of recording medium, conveyance of the sheet S, etc.

The control portion 10 is capable of carrying out a control sequence for controlling the toner supplying device 8 so that the developing device 4 is replenished with a fresh supply of toner by an amount which is in accordance with the toner density of the developer in the developing device 4, which is determined based on the results of the inductance detection by the sensor 60. The control sequence for controlling the operation for replenishing the developing device 4 with a fresh supply of toner is described later (FIG. 5).

### Embodiment 1

Referring to FIGS. 3-5, the developing device 4 in the first embodiment of the present invention is described. Referring to FIGS. 3 and 4, the developing device 4 has: a developer container 22, which doubles as the housing of the developing device 4; a development sleeve 28 as a developer bearing member; a regulation blade 29; a development screw 25 as the first conveyance screw; a stirring screw 26 as the second conveyance screw; etc.

The developer container 22 stores two-component developer which contains nonmagnetic toner and magnetic carrier. That is, the developing method used in this embodiment is such a developing method that uses two-component developer, which is a mixture of nonmagnetic toner which tends to become negatively charged, and magnetic carrier which tends to become positively charged. The nonmagnetic toner is made of a mixture of such resin as polyester and styrene-acrylic, coloring agent, wax, etc. It is formed by pulverization or polymerization. The magnetic carrier is made up of resinous particles; core particles are made by mixing ferrite particles with magnetic particles, kneading the fixture, drying the kneaded mixture, ad pulverizing the dried mixture, and the resultant particles are coated with resin. In this embodiment, the toner density (weight ratio of toner in developer, which is sometimes referred to as “TD ratio”) is 8%, for example.

The developer container 22 has an opening which faces the photosensitive drum 1. The development sleeve 28, which is a developer bearing member, is rotatably disposed in the developer container 22 in such a manner that it is partially exposed from the developer container 22 through the abovementioned opening. The development sleeve 28 is cylindrical. It is formed of a nonmagnetic substance such as aluminum alloy. It is rotationally driven in the direction indicated by an arrow mark R3 in FIG. 3. In the hollow of the cylindrical development sleeve 28, a stationary magnetic roller 281, which is provided with multiple magnetic poles, is disposed as a magnetic field generating means.

Referring to FIG. 3, the development sleeve 28 is rotated in the direction indicated by the arrow mark R3. As it is rotated, the developer in the developer container 22 adheres to the portion of the development sleeve 28, which corresponds in position to the pickup magnetic pole N1 of the magnetic roller 281, and then, is conveyed toward the regulation blade 29 by the subsequent rotation of the development sleeve 28 while being made to crest by the regulation magnetic pole S1. Then, as the crested portion of the developer on the peripheral surface of the development sleeve 28 is moved through the gap between the development sleeve 28 and regulation blade 29, its top portion is sheared away by the regulation blade 29, being thereby controlled in the amount per unit area. That is, a developer layer having a preset thickness is formed on the peripheral surface of the development sleeve 28. Then, the developer layer is conveyed further by the subsequent rotation of the development sleeve 28, to the development area, in which the developer layer opposes the peripheral surface of the photosensitive drum 1, and also, in which it is made to form a magnetic brush by the development magnetic pole N2, and develops the electrostatic latent image on the peripheral surface of the photosensitive drum 1 (FIG. 1). After being used for the development, the developer separates from the development sleeve 28 while it is moved through the nonmagnetic area which is between the stripping magnetic pole N3 and pickup magnetic pole N1, in terms of the rotational direction of the development sleeve 28. The stripping magnetic pole N3 and pickup magnetic pole N1 are the same in polarity.

### <Developer Container>

The developer container 22 has: a development chamber 23 as the first chamber; a stirring chamber 24 as the second chamber; and a partition wall 27 which is between the development chamber 23 and stirring chamber 24 to separate the development chamber 23 from the stirring chamber 24. The partition wall 27 separates the development chamber 23 from the stirring chamber 24 by perpendicularly extending inward of the developer container 22 from the bottom wall of the developer container 22. Further, the partition wall 27 extends also in the direction (lengthwise direction) parallel to the rotational axis of the development sleeve 28. The lengthwise direction of the development chamber 23 and that of the stirring chamber 24 are parallel to the rotational axis of the development sleeve 28. Further, the developing device 4 in this embodiment is structured so that when it is in the upright position, the bottom surface 24a of the stirring chamber 24 is positioned higher than the bottom surface 23a of the development chamber 23. That is, as the developing device 4 is seen from the horizontal direction, there is a difference in height between the development chamber 23 and stirring chamber 24. Further, the developer container 22 (developing device 4) is constructed so that the inward surface of the bottom portion 24a of the stirring chamber 24 is a part of the inward surface of the bottom wall of the developer container 22, which is angled relative to the horizontal direction.

Referring to FIG. 4, the partition wall 27 is provided with the first and second developer passages 91 and 92 (which hereafter may be referred to simply as first and second passages 91 and 92, respectively) which are at the lengthwise ends of the partition wall 27, one for one. The two passages 91 and 92 function as the developer passages between the development chamber 23 and stirring chamber 24. That is, the lengthwise ends of the partition wall 27 do not reach the corresponding lengthwise ends of the developer container 22, providing the developer container 22 with the first and second passages 91 and 92 which allow the developer in the developer container 22 to move from the stirring chamber 24 to the development chamber 23, and from the development chamber 23 to the stirring chamber 24, respectively. Referring to FIG. 3, the developer container 22 is provided with a guiding member 271 which guides the developer recovered from the development sleeve 28, into the stirring chamber 24. It is attached to the partition wall 27, at a preset angle, as if it is extended diagonally upward from the top edge of the partition wall 27.

Further, the developing device 4 is provided with a development screw 25, which is disposed, as the first conveying member, in the development chamber 23 to convey the developer in the development chamber 23. The developing device 4 is also provided with a stirring screw 26, as the second conveying member, which is disposed in the stirring chamber 24 to convey the developer in the opposite direction from the direction in which the developer is conveyed by the development screw 25. The development screw 25 and stirring screw 26 are made up of rotational shafts 25a and 26a, and the first and second blades 25b and 26b (which hereafter may be referred to simply as “blade”) spirally formed around the rotational shafts 25a and 26a, respectively. The lengthwise ends of each of the rotational shafts 25a and 26a are rotatably supported by the developer container 22. The development screw 25 and stirring screw 26 are disposed in such a manner that as they are seen from the horizontal direction, they at least partially overlap with each other. In this embodiment, the developing device 4 is structured so that the rotational shaft 26a of the stirring screw 26 is positioned higher than the rotational shaft 25a of the development screw 25, and also, so that the two shafts 26a and 25a are roughly parallel to each other. Also in this embodiment, the rotational shafts 25a and 26a are 7 mm in diameter, and the spiral blades 25b and 26b are 18 mm in diameter and 20 mm in pitch. The development screw 25 and stirring screw 26 are disposed so that they are opposite in the direction of their spiral blade. Therefore, they are opposite in the direction in which they convey the recovered developer. By the way, it is desired that the blades 25b and 26b are the same in blade pitch. Further, it is unnecessary that the development screw 25 and stirring screw 26 are the same in external diameter.

The stirring screw 26 is provided with a return blade 26c, in addition to the blade 26b, or the main blade. The return blade 26c is capable of conveying the developer in the opposite direction from the direction in which the developer is conveyed by the blade 26b. It is on the downstream side of the blade 26b in terms of the developer conveyance direction of the blade 26b. The return blade 26c functions as a screw for pushing the developer back toward the blade 26b in the stirring chamber 24 as the developer is conveyed to the return blade 26c. Since the return blade 26c pushes back the developer, the developer conveyed to the end of the stirring chamber 24 is more likely to be transferred into the development chamber 23 through the first passage 91 than in a case where the stirring screw 26 is not provided with the return blade 26c. Therefore, when the top surface of the body of developer which is being conveyed in the developer container 22 is stable in condition, the top surface of the portion of the body of developer, which corresponds in position to the first passage 91, is higher in position than the surfaces of the other portions of the developer.

The developing device 4 is structured so that the development sleeve 28, development screw 25, and stirring screw 26 are driven together through an unshown gear train; they are rotated by the same unshown motor by way of the gear train. The development screw 25 and stirring screw 26 are rotated at a preset rotational speed (600 rpm, for example), whereby the developer is conveyed in the direction indicated by arrow mark in FIG. 4. In this embodiment, the development screw 25 and stirring screw 26 are rotated at the same rotational speed. As the development screw 25 and stirring screw 26 are rotated, the developer is transferred from the stirring chamber 24 to the development chamber 23 through the first passage 91, and from the development chamber 23 to the stirring chamber 24 through the second passage 92. Thus, a combination of the development chamber 23 and stirring chamber 24 forms a developer circulation loop. The developer is stirred and mixed as it is moved through the developer container 22 through this developer circulation loop.

Referring to FIG. 3, the development screw 25 rotates in the direction indicated by an arrow mark R5, that is, such direction that causes the opposite portion of the development screw 25 from the partition wall 27, to move upward from the bottom wall 25a of the development chamber 23, whereas the stirring screw 26 rotates in the direction indicated by an arrow mark R4, that is, such direction that causes the opposite portion of the stirring screw 26 from the partition wall 27, to move upward from the bottom wall 24a of the stirring chamber 24. That is, the development screw 25 rotates in such direction that the portion of the development screw 25, which is adjacent to the partition wall 27, moves downward, and the stirring screw 26 rotates in such a direction that the portion of the stirring screw 26, which is adjacent to the partition wall 27, also moves downward. Thus, the developer smoothly flows through the first passage 91, and is likely to remain stable in bulk density while it is in the first passage 91.

In the development chamber 23, the developer is supplied to the development sleeve 28. In the stirring chamber 24, the developer is recovered as it is separated from the development sleeve 28. That is, the developer in the development chamber 23 is adhered to the development sleeve 28 while being conveyed by the development screw 25, in the area which corresponds in position to the pickup magnetic pole N1 of the magnetic roller 281. By the way, the developing device 4 is structured so that the guiding member 271 attached to the top edge of the partition wall 27 extends from the top edge of the partition wall 27 in such a direction and an attitude that its top edge is in the adjacencies of the development sleeve 28. Therefore, as the developer is separated from the development sleeve 28 by the stripping magnetic pole N3, it is stored in the stirring chamber 24 without being returned to the development chamber 23. In the stirring chamber 24, the recovered developer is conveyed by the stirring screw 26.

As described above, the developing device 4 in this embodiment is structured so that the function to supply the development sleeve 28 with the developer is borne by the development chamber 23, whereas the function to recover the developer from the development sleeve 28 is borne by the stirring chamber 24. In the case of this developing device 4, the developer on the development sleeve 28 is recovered across the entire range of the stirring chamber 24 in terms of the lengthwise direction of the stirring chamber 24. That is, the developer is circulated through the developing device 4 through the two developer passages, that is, the first passage which enables the developer to be conveyed from the development chamber 23 to the stirring chamber 24 without being conveyed by way of the development sleeve 28, and the second passage which enables the developer to be directly conveyed from the development sleeve 28 to the stirring chamber 24.

Next, referring to FIG. 3, the stirring chamber 24 is provided with a replenishment opening 70 to which the toner supplying device 8 is connectible. As the developer is supplied to the stirring chamber 24 from the toner supplying device 8 through the replenishment opening 70, it is conveyed by the stirring screw 26. The amount by which toner is supplied from the toner supplying device 8 to the stirring chamber 24 is determined by the control portion 10 (FIG. 2) based on the results of the detection by sensor 60. The control portion 10 controls the toner supplying device 8 according to the toner density determined based on the results of the detection by the sensor 60. That is, the control portion 10 controls the toner supplying device 8 so that the toner supplying device 8 supplies the developer container 22 with developer by such an amount that the toner density of the developer in the developer container 22 remains to be roughly 8%, for example. Thus, the developer container 22 is replenished with toner by an amount which is roughly the same as the amount by which toner was consumed for image formation.

<Control Sequence for Replenishing Developer Container with Toner>

Next, referring to FIG. 5, the control sequence which is carried out by the control portion 10 to replenish the developer container 22 with a fresh supply of toner is described. The control portion 10 is capable of carrying out the control sequence for replenishing the developer container 22 with a fresh supply of toner, while carrying out an image forming operation started in response to a printing start command signal (image formation command signal) to form an image on a sheet S of recording medium.

Referring to FIG. 5, as the control portion 10 receives a printing operation start signal, it begins the pre-rotation of the image forming apparatus 100. That is, it begins to rotate the development sleeve 28, development screw 25, and stirring screw 26 to stir the developer in the developer container 22 (S1). Next, the control portion 10 obtains the value of the voltage detected by the sensor 60 after the elapse of a preset length of time since the starting of the pre-rotation (S2). Then, the control portion 10 determines the amount by which the developer container 22 is to be replenished with toner by the toner supplying device 8, based on the toner density in the developer container 22, which was obtained based on the obtained voltage value (S3). To describe in greater detail, the control portion 10 obtains the average value, per rotation of screws, of the voltage obtained from the sensor 60, and then, determines the toner density of the developer in the developer container 22, based on the average voltage value, with reference to the data regarding the relationship between the voltage value and toner density, stored in advance in the memory 11. Then, the control portion 10 determines the amount by which the developer container 22 is to be replenished with toner, based on the determined toner density. The control portion 10 replenishes the developer container 22 with replenishment developer (toner) by controlling the toner supplying device 8 (S4). Then, the control portion 10 makes the image forming apparatus 100 carry out the ongoing image forming operation (S5). Then, the control portion 10 determines whether or not the image formation is to be ended (S6). If it determines that the ongoing image forming operation is not to be ended (No in S6), it returns to Step 2, and repeats Steps S2-S6. If the control portion 10 determines that the ongoing image forming operation is to be ended (Yes in S6), it makes the image forming apparatus 100 go through the post-rotation process, and ends the image formation. It is through the above-described processes that the toner density of the developer in the developing device 4 (developer container 22, to describe accurately) is kept in a preset range (roughly 8%).

### <Inductance Sensor>

In this embodiment, the inductance sensor 60 is used to determine the toner density of the developer in the developer container 22. The sensor 60 (as detecting portion) is such a sensor that can output voltage, the value of which is proportional to the magnetic permeability of the developer, with the use of the inductance of a coil with which it is provided. More specifically, it is provided with a coil, which is disposed at the detection surface 60a of the sensor 60. The inductance of this coil is affected by the magnetic permeability of the developer. More specifically, as the developer in the developer container 22 reduces in toner density, the magnetic carrier in the developer increases in its ratio per volumetric unit of developer. Consequently, the developer in the developer container 22 increases in magnetic permeability, which in turn increases the voltage which the sensor 60 outputs. On the other hand, as the developer in the developer container 22 increases in toner density, the magnetic carrier reduces its volumetric ratio in the developer, which in turn reduces the developer in apparent magnetic permeability, which in turn decreases the sensor 60 in output (voltage value).

Further, as the developer in the developer container 22 changes in bulk density, the sensor 60 changes in output voltage value, even if the developer does not change in toner density. If the developer is high in bulk density, the magnetic carrier in a unit volume of developer increases in bulk density, which in turn increases the developer in apparent magnetic permeability, which in turn increases the sensor 60 in output (voltage value). On the other hand, as the developer reduces in bulk density, the magnetic carrier in a unit volume of developer reduces in density, which in turn reduces the developer in magnetic permeability, which in turn reduces the sensor 60 in output (voltage).

In this embodiment, therefore, the sensor 60 is disposed so that at least its detection surface 60a is placed in the first passage 91, that is, an area in the developer container 22, in which the developer is unlikely to change in bulk density, and in which the developer is unlikely to become stagnant, in consideration of the above-described facts. Thus, it is possible to minimize the effects of the changes in the bulk density of the developer in the developer container 22 upon the magnetic permeability of the developer, in order to ensure that only the changes in the magnetic permeability of the developer, which are attributable to the changes in the toner density of the developer in the developer container 22 are reflected in the output of the sensor 60. Next, positioning of the sensor 60 in this embodiment is concretely described.

To begin with, referring to FIG. 4, positioning of the sensor 60 in terms of the lengthwise direction of the developer container 22 (direction parallel to rotational axis of stirring screw 26) is described. Referring to FIG. 4, the sensor 60 (FIG. 4 shows only detection surface 60a for convenience sake) is disposed in the first passage 91, which is on the downstream side of the center of the stirring screw 26 in terms of the developer conveyance direction of the stirring screw 26, which is parallel to the rotational axis of the stirring screw 26. Further, it is disposed outside the development roller coating range H (developer bearing range), in which the developer can be borne by the development sleeve 28. Further, the sensor 60 is attached to the slanted bottom wall (both bottom wall 24a of stirring chamber 24 and bottom wall 23a of development chamber 23, in FIG. 3, technically speaking) of the developer container 22 so that its detection surface 60a is exposed inward of the developer container 22.

The sensor 60 (detection surface 60a, technically speaking) is disposed in the first passage 91 so that it extends from the lengthwise end of the partition wall 27 close to return blade 26c. However, it is desired that the sensor 60 is disposed so that the detection surface 60a is positioned close to the partition wall 27. More concretely, it is desired that the sensor 60 is disposed so that the detection surface 60a is placed no father than a distance (20 mm, for example) equivalent to the pitch of the blade 26b from the lengthwise end of the partition wall 27, because the closer is the body of developer to the lengthwise end of the partition wall 27, the higher the body of developer is in greater in movement, and the further the body of developer from the lengthwise end of the partition wall 27, the less the body of developer is in movement. Further, in a case where the sensor 60 is disposed so that the detection surface 60a is placed close to the blade 26c, more of the developer is made to slide down into the development chamber 23 by gravity, through the portion of the first passage 91, which is next to the lengthwise end of the partition wall 27 than through the portion of the first passage 91, which corresponds in position to the detection surface 60a. That is, the developer does not slide down on the detection surface 60a by an amount which is sufficient to accurately measure the developer in bulk density.

Next, referring to FIG. 3, positioning of the detection surface 60a in terms of the widthwise direction (which is intersectional to rotational axis of stirring screw 26) is described. In terms of the widthwise direction of the developer container 22, the sensor 60 is disposed so that the detection surface 60a is placed in a range (indicated by letter L in FIG. 3), which corresponds to the interval between the first and second vertical lines which coincide with the rotational axes of the rotational shafts 25a and 26a, respectively. The shaft interval L is relatively large in the amount by which the developer is transferred from the stirring chamber 24 to the development chamber 23; the body of developer in the shaft interval L is frequently replaced.

By the way, it is desired that the detection surface 60a is placed on the first vertical straight line side, that is, the development screw side (first conveyance screw side), of the center of the shaft interval L. Further, it is preferred that the detection surface 60a is positioned so that, in terms of vertical direction, it at least partially overlaps with the development screw 25. Further, the portion of the internal space of the developer container 22, which is directly below the development screw 25, is characterized in that the body of developer therein is more frequently replaced than in the other portions of the internal space of the developer container 22, and also, that it is more likely to remain stable in the bulk density of the developer. That is, the area which is directly below the development screw 25 is characterized in that the developer in the developer container 22 is unlikely to become stagnant in this area, and also, that the area is more likely to remain stable in the bulk density of the developer. In other words, it is the best location for the detection surface 60a. However, even if the detection surface 60a is placed directly below the development screw 25, if the area in which the detection surface 60a is placed is outside the area L (interval) between the aforementioned two vertical lines which coincide with the axes of the stirring screw 26 and development screw 25, the developer is likely to become stagnant, that is, the developer is unlikely to continuously move. Thus, areas which are outside the area L (interval) are not suitable as the locations for the detection surface 60a. As described above, in terms of the lengthwise direction of the developing device 4, the detection surface 60a is placed in the first passage 91. In terms of the direction (sectional view) which is perpendicular to the lengthwise direction of the developing device 4, the detection surface 60a is placed in the area between the rotational axis of the first conveyance screw, and the rotational axis of the second conveyance screw. Here, as long as the 90% of the detection surface 60a is within the above-described area, it is deemed that the detection surface 60a is practically in the above-described area.

As described in the foregoing, the developing device 4 in this embodiment is disposed so that the bottom wall 24a of the stirring chamber 24 is positioned higher than the bottom wall 23a of the development chamber 23. Further, for the purpose of ensuring that the developer in the stirring chamber 24 is made by its own weight to slide downward on the bottom wall 24a of the stirring chamber 24 toward the development chamber 23, the developer container 22 is structured so that a combination of the bottom wall 24a of the stirring chamber 24 and the bottom wall 23a of the development chamber 23 forms a flat and continuous wall, at least in the first passage 91. This structural arrangement makes it easier for the body of developer on the bottom wall 24a of the stirring chamber 24 and the body of developer on the bottom wall 23a of the development chamber 23 to be replaced by other bodies of developer. Thus, it can make the sensor 60 remain highly responsive to the changes in the toner density of the developer in the developer container 22. However, if the portion of the bottom wall 22a of the developer container 22, which is in the first passage 91, is excessively tilted, the amount of the pressure which is applied to the detection surface 60a by the developer becomes excessive, and therefore, it is possible that the developer will not smoothly flows across the detection surface 60a. On the other hand, if the angle at which the portion of the bottom wall of the developer container 22, which corresponds in position to the first passage 91, is excessively small, as the top surface of the body of developer in the developer container 22 rises, the developer moves with the stirring screw 26, making it possible that the body of developer on the detection surface 60a will not be stable in bulk density. In this embodiment, therefore, the portion of the bottom wall of the developer container 22, which corresponds in position to the first passage 91, is desired to be angled no less than the angle of repose of developer, preferably, no less than the angle of collapse of developer, relative to the horizontal direction.

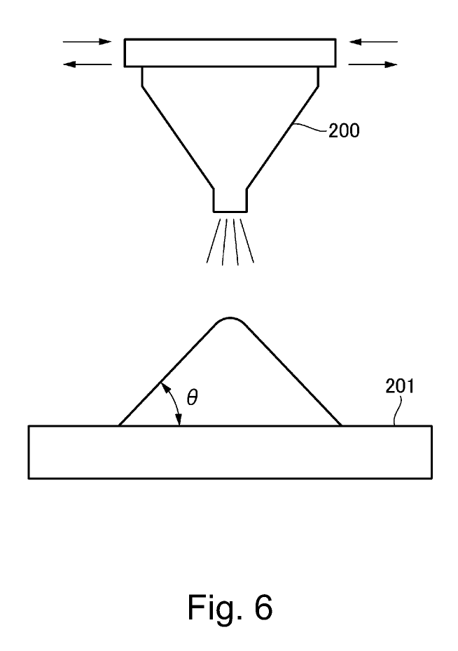

At this time, referring to FIG. 6, the definition of the angle of collapse of developer, and that of the angle of repose of developer, are described. The angle of collapse of developer and the angle of repose of developer can be measured with the use of a powder tester (PT-N: product of Hosokawa Micron Co., Ltd., for example). In order to measure the angle of collapse and angle of repose of the developer, roughly 250 cc, for example, of the developer was placed in a vibration table 200 fitted with a sieve (unshown) which was 246 μm in opening size. Then, the vibration table was activated roughly 180 seconds. As the developer fell through the sieve of the vibration table 200, it accumulated on the table 201 in the shape of a cone as shown in FIG. 6. Then, the angle (θ) which was formed between the slanted surface of this body of the developer shaped like a cone and the horizontal plane, was measured. The thus obtained angle was referred to as the angle of repose of the developer. Thereafter, a shocker (unshown) which was roughly 450 g in weight was repeatedly (three times, for example) dropped onto the table 201 from a height of roughly 1 cm. As the shocker was dropped, the table 201 vibrated, and therefore, the small cone of the developer partially collapsed. Then, the angle (θ) formed between the slanted surface of the collapsed cone of developer and the horizontal plane was measured with the use of an angle measurement arm or the like instrument. The thus obtained angle was referred to as the angle of collapse of the developer. A body of developer, which is shaped like a cone, and the angle of the slanted surface of which is no more than the angle of collapse of the developer, is unlikely to collapse. The developer used in this embodiment was 30° in angle of repose, and 15° in angle of collapse.

As long as the angle of the bottom wall of the first passage 91 is no less than the angle of repose of the developer, the developer in the first passage 91 is likely to be moved toward the development chamber 23 by its own weight. However, even if the angle of the bottom wall of the first passage 91 is no more than the angle of repose of the developer, the developer in the first passage 91 is likely to move toward the development chamber 23, as long as the angle of the bottom wall of the first passage 91 is no less than the angle of collapse of the developer, and the developer is under the force generated by the rotation of the stirring screw 26 in the direction to convey the developer. Therefore, the angle of the bottom wall of the first passage 91 in which the sensor 60 is disposed is desired to be no less than the angle of collapse of the developer, preferably, no less than the angle of repose of the developer, and no more than 45°.

Further, the sensor 60 is constructed so that as it is attached to the bottom wall of the developer container 22, its detection surface 60a becomes roughly level with the inward surface of the bottom wall (combination of bottom wall 24a of stirring chamber 24 and bottom wall 23a of development chamber 23) of the developer container 22, for the following reason. That is, if the portion of the sensor 60, which has the detection surface 60a, is inwardly protrusive by a significant amount relative to the bottom wall of the developer container 22, the developer flow which occurs as the developer slides down on the bottom wall of the developer container 22 from the stirring chamber 24 into the development chamber 23 is interfered by the sensor 60; it cannot be ensured that the developer smoothly flows from the stirring chamber 24 into the development chamber 23. On the other hand, if the detection surface 60a is recessed from the inward surface of the bottom wall of the developer container 22, a certain amount of the developer collects in the recess. That is, also in this case, it cannot be ensured that the developer smoothly flows from the stirring chamber 24 into the development chamber 23. Therefore, it is desired that the sensor 60 is constructed and disposed so that the amount by which the detection surface 60a protrudes from the bottom wall of the developer container 22 is no more than 1 mm.

The inventors of the present invention carried out experiments for comparing the developing device 4 in this embodiment with a comparative developing device, which will be described later, in the amount of toner density error. More concretely, images were continuously formed on 30,000 sheets of recording medium, one for one, using each of the developing device 4 and the comparative developing device, while detecting the inductance of the developer in the developer container 22, for every 5000th sheet, to obtain the errors [%] in the toner density, which is the difference between the toner density obtained based on the results of the detection of the developer inductance by the sensor 60 and the predicted toner density (predicted value).

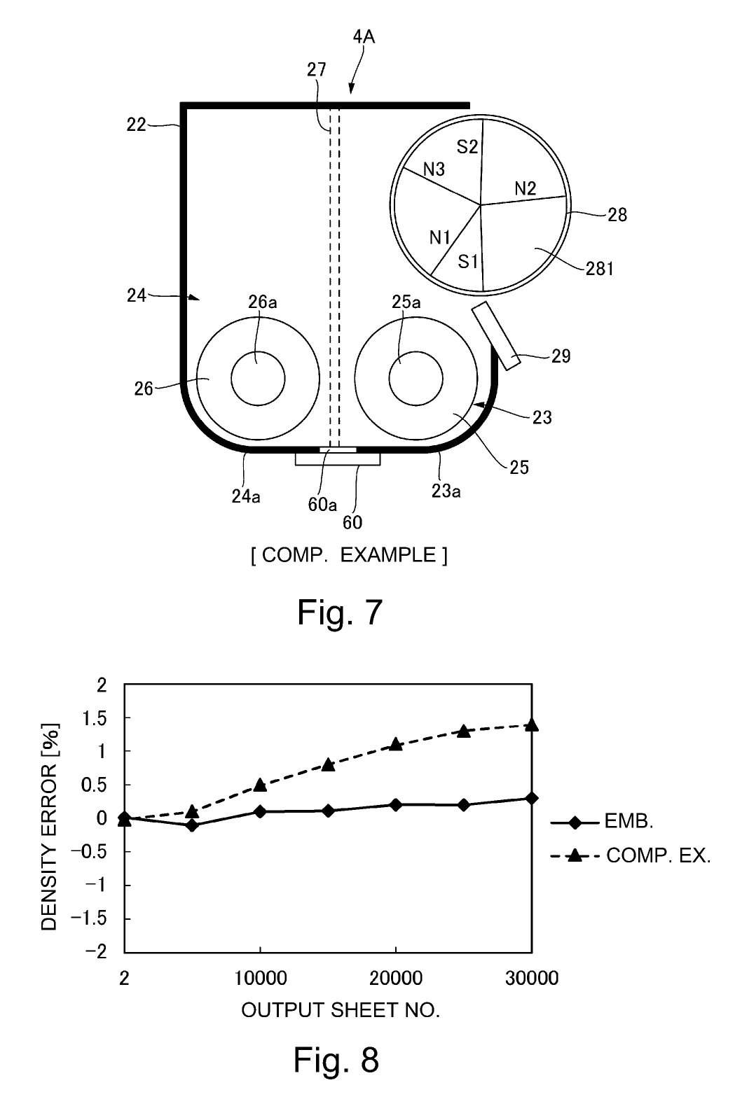

It is one of the comparative developing devices used for the experiments that is shown in FIG. 7. The developing device 4A shown in FIG. 7 is different from the developing device 4 in the first embodiment (FIG. 2) in that its partition wall 27 is not provided with the guiding member 271, and also, that the comparative developing device 4A is constructed so that its development chamber 23 and stirring chamber 24 are roughly at the same level. Since the partition wall 27 of the developing device 4A is not provided with the guiding member 27, not only does its development chamber 23 supply the development sleeve 28 with the developer, but also recovers the developer as the developer separates from the development sleeve 28. That is, unlike the developing device 4 in this embodiment, the comparative developing device 4A is not structured so that the function of supplying the development sleeve 28 with the developer is carried out by the development chamber 23 whereas the function of recovering the developer is carried out by the development chamber 23.

Further, as will be evident from FIG. 7, in the case of the comparative developing device 4A, the development chamber 23 and stirring chamber 24 are at the same level. That is, the bottom wall 24a of the stirring chamber 24 and the bottom wall 23a of the development chamber 23 are level with each other. Further, the development screw 25 and stirring screw 26 are positioned so that their rotational shafts 25a and 26a, respectively, are at the same level, and parallel to each other. Moreover, the sensor 60 is attached to the bottom wall of the first passage 91 (FIG. 4) so that its detection surface 60a is exposed inward of the developer container 22 (first passage 91). However, the bottom wall of the developer container 22, that is, a combination of the bottom wall 24a of the stirring chamber 24 and the bottom wall 23a of the development chamber 23 is not tilted; it is flat and horizontal.

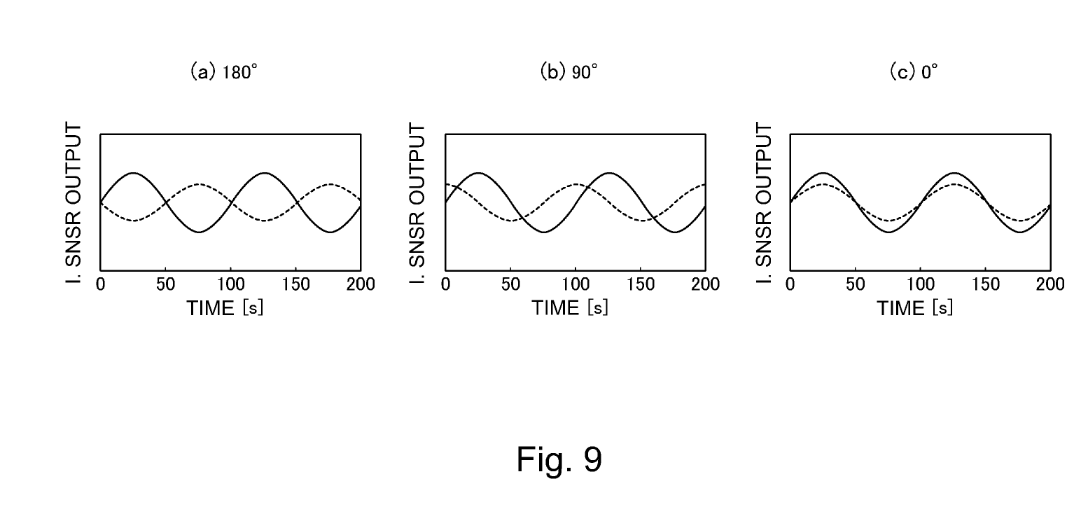

FIG. 8 shows the differences in toner density error between the developing device 4 in this embodiment and the comparative developing device 4A. In FIG. 8, the toner density errors of the developing device 4 in this embodiment are indicated by a solid line, whereas those of the comparative developing device 4A are indicated by a dotted line. Referring to FIG. 8, in the case of the comparative developing device 4A, as it increases in the cumulative image formation count (number of outputted prints), it increases in the toner density errors, because it is where the developer slowly moves that the sensor 60 detects the changes in magnetic field. Also in the case of the comparative developing device 4A, the bottom surface (combination of bottom walls 23a and 24a) of the developer container 22 of which is not tilted, and therefore, the developer transfer in the first passage 91 is mostly dependent upon the rotation of the stirring screw 26 and that of the development screw 25. That is, in the first passage 91 in which the top surface of the body of developer therein is made to rise by the rotation of each screw, the developer in the upper layer of the body of developer which is closer to the top surface is likely to be easily moved, whereas the developer in the bottom layer of the body of developer, which is closer to the bottom wall 22a of the developer container 22 is unlikely to be easily moved. That is, the developer in the bottom layer of the body of developer in the first passage 91 is likely to become stagnant. Thus, the body of developer on the detection surface 60a is less likely to be replaced by another body of developer. Therefore, the comparative developing device 4A is likely to deviate in toner density from the preset one.

In comparison, in the case of the developing device 4 in this embodiment, the toner density errors remained relatively small regardless of the cumulative image formation count as shown in FIG. 8, as described previously. That is, the sensor 60 was attached to the slanted bottom portion of the first passage 91. Therefore, even the developer in the bottom layer of the body of developer, which is adjacent to the bottom wall of the developer container 22, and to which the developer conveyance force generated by the rotation of the stirring screw 26 and that of the development screw 25 do not reach as much as it does to the developer in the top layer of the body of developer in the first passage 91, is moved from the stirring chamber 24 to the development chamber 23. That is, it is unlikely for the developer in the developer container 22 to become stagnant in the adjacencies of the bottom wall of the developer container 22. That is, the developer does not become stagnant on the detection surface 60a. Therefore, the developing device 4 in this embodiment is unlikely to significantly deviate in toner density from the preset one.

As described above, the developing device 4 in this embodiment is constructed so that the function of supplying the development sleeve 28 with the developer is performed by the development chamber 23, whereas the function of recovering the developer from the development sleeve 28 is performed by the stirring chamber 24. Further, the inductance sensor 60 is attached to the slanted bottom wall of the first passage 91. Thus, while the development screw 25 and stirring screw 26 are rotated and the top surface of the body of developer is stable, the first passage 91 which connects the stirring chamber 24 to the development chamber 23, at the downstream end of the development chamber 23 in terms of the developer conveyance direction, is greater in the amount of the developer than other parts of the developer container 22. However, the bottom wall of the first passage 91 is tilted, making it likely for the body of developer which is in the adjacencies of the bottom wall to be slid down by gravity (its own weight). Therefore, even though the first passage 91 is slightly greater in the amount of the developer than the other portions of the developer container 22, the developer is smoothly transferred from the stirring chamber 24 to the development chamber 23. Further, because the first passage 91 is greater in the amount of developer, the body of developer on the detection surface 60a is subjected to a greater amount of pressure which is attributable to its own weight, being therefore unlikely to significantly change in bulk density. That is, while a body of developer is in the first passage 91, it remains stable in bulk density. Since the inductance sensor 60 is attached to the slant bottom wall of the first passage 91, in which the developer continuously moves, and stable in bulk density, as described above, the sensor 60 is enabled to more accurately detect the toner density of the developer in the developer container 22 than a sensor (60) in any conventional developing device (4).

As described above, the sensor 60 detects the changes in the magnetic field, which are attributable to the changes in the magnetic permeability of the developer. However, the magnetic permeability of developer is also affected by the bulk density of developer. For example, even if two bodies of developer are the same in toner density, the body of developer which is higher in bulk density is higher in magnetic permeability than the body of developer which is lower in bulk density. Further, while a body of developer is on the detection surface 60a, it is made to periodically change in bulk density because of the influence which the rotation of the stirring screw 26 and that of the development screw 25 have on the body of developer. In particular, referring to FIG. 4, in a case where the blades 25b and 26b are long enough, in the direction parallel to their rotational axes, to be in the first passage 91, the bulk density of the body of developer in the first passage 91 is likely to be affected by the rotation of the stirring screw 26 and development screw 25. In a case where the bulk density of the body of developer in the first passage 91 is slightly changed by the effects of the rotation of the stirring screw 26 and development screw 25, the voltage which the sensor 60 detects is likely to change in the form of a wave (voltage waveform) during each rotation of the screws; the line in the aforementioned graphs (parts (a)-(c) of FIG. 9) which shows the detected voltage have ripples, which may change in position and amplitude. Therefore, the results of the detection by the sensor 60 do not remain the same even under the same condition. Therefore, in a case where the toner density is obtained based on the output of the sensor 60, which is in the form of a wave (toner density graph has ripples), it is desired that the effects of the ripples be minimized.

Thus, in consideration of the above-described facts, the developing device 4 in this embodiment is adjusted in the rotational phase of the blade 26b and 25b, in order to stabilize the sensor 60 in output. The following is the description of the phase adjustment of the blades 26b and 25b.

To begin with, parts (a)-(c) of FIG. 9 show the changes which occurred to the output of the sensor 60 when the blade 26b of the stirring screw 26 and the blade 25b of the development screw 25 were made different in phase, and each screw was rotated while the other was not. The blades 26b and 25b were made different in phase so that the output of the sensor 60, which was related to the blade 26b became different in the peak (or valley) of waveform from the output of the sensor 60, which was related to the blade 25b. Part (a) of FIG. 9 shows the changes in the output of the sensor 60 when the blades 26b and 25b were different in phase by 180°; part (b) of FIG. 9, 90°; and part (c) of FIG. 9, 0°. In these graphs, a dotted line shows the changes which occurred to the output of the sensor 60 when the development screw 25 alone was rotated, and a solid line shows the changes which occurred to the output of the sensor 60 when the stirring screw 26 alone was rotated.

As will be understood from parts (a)-(c) of FIG. 9, the output of the sensor 60 periodically changes in synchronism with the rotation of each screw, because the pressure generated by the blades 26b and 25b in the direction to press the developer upon the detection surface 60a as the stirring screw 26 and development screw 25 are rotated periodically changes in magnitude. More specifically, the closer the blades 26b and 25b to the detection surface 60a, the greater the amount of pressure by which the developer is pressed toward the detection surface 60a, and therefore, the higher does the developer become in bulk density, which in turn increases the sensor 60 in output (voltage). On the other hand, while the blades 26b and 25b move away from the detection surface 60a, the developer is unlikely to be pressed toward the detection surface 60a, and therefore, the developer reduces in bulk density, which in turn reduces the sensor 60 in output (voltage).

Regarding the phase of the blade 26b, the timing with which both the outermost edge of the blade 26b in terms of the diameter direction of the blade 26b, and the outer edge of the blade 25b in terms of the diameter direction of the blade 25b, which corresponds in position to the outermost edge of the blade 26b in terms of the direction parallel to the rotational axes of the two screws, become closest to the partition wall 27 at the same time while the stirring screw 26 and development screw 25 are rotated is defined as phase 0°. Further, the timing with which the outermost edge of the blade 26b in terms of the diameter direction of the blade 26b, becomes closest to the partition wall 27, and at the same time, the outermost edge of the blade 25b in terms of the diameter direction of the blade 25b, which corresponds in position to the outermost edge of the blade 26b in terms of the direction parallel to the rotational axes of the two screws 26 and 25, is defined as phase 180°. In a case where the stirring screw 26 and development screw 25 are disposed so that the blade phase becomes 0°, the fluctuation of the output of the sensor 60, which is caused by the rotation of the stirring screw 26 and that by the rotation of the development screw 25 become synchronous (part (c) of FIG. 9). However, in a case where the two screws 26 and 25 are disposed so that the blade phase becomes 180°, there occurs roughly 180° of deviation between the fluctuation of the output of the sensor 60, which is attributable to the rotation of the stirring screw 26, and that to the rotation of the development screw 25 (part (a) of FIG. 9).

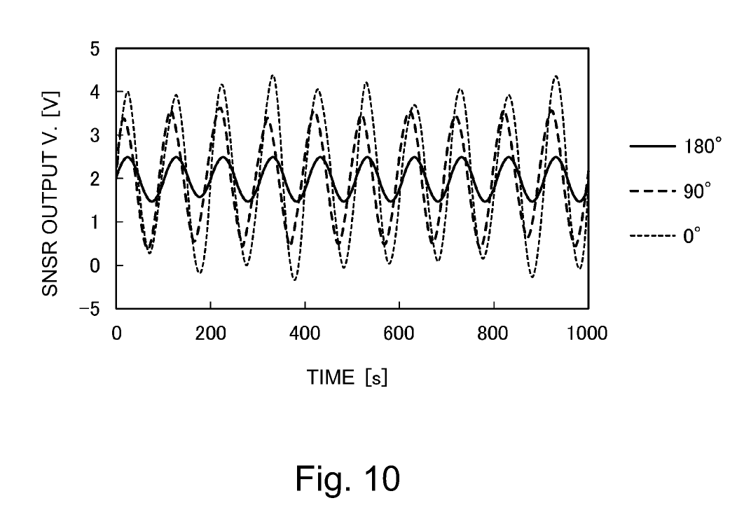

Next, FIG. 10 shows the periodical changes (in a pattern of wave) which occurred to the output of the sensor 60 with the elapse of time when the stirring screw 26 and development screw 25 were simultaneously rotated, with the two screws 26 and 25 being disposed so that the blades 26b and 25 became different in phase. In FIG. 10, a solid line represents the case in which the blade phase was 180°; a bold line, 90°; and a fine line, 0°. In this embodiment, a preset control voltage is applied to the sensor 60 by an unshown electric power source so that the average output voltage value, per rotation of screws, of the sensor 60 becomes 2 (V).

Referring to FIG. 10, when the blade phase was 90° or 0°, the output of the sensor 60 significantly fluctuated (large in amplitude in waveform), for the following reason. That is, the timing with which the developer is sent to the second passage 92 by the development screw 25, and the timing with which the developer is sent to the first passage 91, roughly coincide. In particular, the closer is the blade phase to 0°, the closer is the second passage 92 and first passage 91 in the timing with which the periodical changes occur to the bulk density of the developer. In this case, the changes which occurs to the output of the sensor 60 when the stirring screw 26 alone is rotated, are added to the changes which occurs to the output of the sensor 60 when the development screw 25 alone is rotated (part (b) of FIGS. 9 and 9(c)). Thus, the sensor 60 outputs such voltage that is greater in the amplitude of its waveform. However, the ripples also add up, becoming therefore greater in amplitude. Therefore, it is possible that the ripples will significantly affect the average voltage value, per screw rotation, of the sensor 60. If this occur, it is impossible to accurately determine the toner density of the developer based on the output of the sensor 60.

In comparison, in a case where the blade phase is 180°, the sensor 60 outputs voltage having such a waveform that its average value is very close to the average output value (2 V), per rotation of screws, of the sensor 60, for the following reason. That is, in the case where the blade phase is 180°, the timing with which the developer is sent to the second passage 92 is offset by a half turn of the screws from the timing with which the developer is sent to the first passage 91 by the stirring screw 26. Thus, the sensor 60 outputs such voltage that its waveform is less in amplitude (part (a) of FIG. 9). Further, the ripples also are reduced in amplitude, and therefore, the ripples are less likely to have significant effects upon the average output (voltage) value of the sensor 60 per rotation of the screws.

In consideration of the above-described facts, it is desired that the difference in phase between the blades 26b and 25b is set to be no less than 30° and no more than 180°. In this embodiment, the difference in phase between the blades 26b and 25b was set to roughly 180° C. Thus, it was possible to make the periodical changes which were caused to the output of the sensor 60 by the rotational of the stirring screw 26 offset by roughly 180° from those which were caused to the output of the sensor 60 by the rotation of the development screw 25 (part (a) of FIG. 9). Therefore, it was possible to reduce the effects of the ripples. If it is possible to reduce the effects of the ripple, the average value, per rotation of screws, of the voltage output of the sensor 60 is closer to the presumed value. Therefore, it is possible to determine the toner density of the developer in the developer container 22 based on the output of the sensor 60, at a higher level of accuracy than by any conventional developing device.

By the way, the stirring screw 26 and development screw 25 can be adjusted in phase by the adjustment of the gear train (unshown), which is in connection to the development screw 25 and stirring screw 26 to drive them, in the positioning and/or meshing of the teeth of its gears.

### MISCELLANIES

By the way, in the case of the above-described embodiment of the present invention, the image forming apparatus 100 was of the so-called intermediary transfer type. That is, the image forming apparatus 100 transferred (primary transfer) four monochromatic toner images, different in color, from the four photosensitive drums 1, one for one, onto the intermediary transfer belt 5, and then, transferred together (secondary transfer) the four monochromatic toner images (of which multicolor toner image is formed) onto a sheet S of recording medium. However, the embodiment is not intended to limit the present invention is scope. For example, the present invention is also applicable to an image forming apparatus of the so-called direct transfer type, which directly transfers a toner image (toner images) onto a sheet S of recording medium while the sheet S is being conveyed by a transfer medium conveyance belt by being borne by the belt.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-025109 filed on Feb. 12, 2016, which is hereby incorporated by reference herein in its entirety.

What is claimed is:

1. A developing device comprising:
a rotatable developer carrying member configured to carry a developer containing toner and carrier;
a first chamber provided opposed to said developer carrying member to supply the developer to said developer carrying member; a second chamber provided opposed to said developer carrying member to collect the developer from said developer carrying member;
a first feeding screw configured to feed the developer in said first chamber in a first direction;
a second feeding screw configured to feed the developer in said first chamber in a second direction which is opposite the first direction;
a partition configured to partition between said first chamber and said second chamber and including a first communicating portion configured to feed the developer from said second chamber to said first chamber, and a second communicating portion configured to feed the developer from said first chamber to said second chamber; and
a toner content sensor configured to detect a toner content of the developer;
wherein said toner content sensor is disposed so as to detect the developer in a region which is in said first communicating portion with respect to rotational axis direction of said developer carrying member and which is between a rotation axis of said first feeding screw and a rotation axis of said second feeding screw with respect to a direction perpendicular to the rotational axis direction.

2. A device according to claim 1, wherein said toner content sensor has a detection surface disposed at a bottom surface of said first communicating portion in a region which is in said first communicating portion with respect to the rotational axis direction of said developer carrying member and which is between the rotation axis of said first feeding screw and the rotation axis of said second feeding screw.

3. A device according to claim 1, wherein with respect to a vertical direction, a bottom surface of said second chamber opposed to said second feeding screw is at a higher level than a bottom surface of said first chamber opposed to said first feeding screw.

4. A device according to claim 1, wherein with respect to a vertical direction, said developer carrying member is disposed at a level higher than said first feeding screw.

5. A device according to claim 1, wherein said toner content sensor is disposed in a first feeding screw side of a central position of a distance between the rotational axis of said first feeding screw and the rotational axis of said second feeding screw.

6. A device according to claim 3, wherein a bottom surface of said first communicating portion is inclined relative to a horizontal direction, and the detection surface of said toner content sensor is disposed along the inclined surface.

7. A device according to claim 1, wherein said detecting portion is projected beyond the bottom surface by an amount not more than 1 mm.

8. A device according to claim 6, wherein the inclined surface is inclined relative to the horizontal direction by not more than 45°.

9. A device according to claim 1, wherein said first fitting screw and said second fitting screw are disposed at respective phases which are different by not less than 30° from each other.

10. A device according to claim 9, wherein said first feeding screw and said second feeding screw are disposed with 180° deviation of the phase such that the edge portion of said second blade most remote from said partition when the edge portion of said first blade is closest to said partition during the rotation.

11. A device according to claim 1, wherein said second feeding screw feeds the developer to a neighborhood of said second communicating portion in a direction opposite to the second direction.

12. A device according to claim 1, wherein said toner content sensor is an inductance sensor.

13. An image forming apparatus comprising:
an image bearing member;
a developing device including,
(i) a rotatable developer carrying member configured to carry a developer containing toner and carrier; (ii) a first chamber provided opposed to said developer carrying member to supply the developer to said developer carrying member; (ii) a second chamber provided opposed to said developer carrying member to collect the developer from said developer carrying member; (iv) a first feeding screw configured to feed the developer in said first chamber in a first direction; (v) a second feeding screw configured to feed the developer in said first chamber in a second direction which is opposite the first direction; (vi) a partition configured to partition between said first chamber and said second chamber and including a first communicating portion configured to feed the developer from said second chamber to said first chamber, and a second communicating portion configured to feed the developer from said first chamber to said second chamber; and
a toner content sensor configured to detect a toner content of the developer;
wherein said toner content sensor is disposed so as to detect the developer in a region which is in said first communicating portion with respect to rotational axis direction of said developer carrying member and which is between a rotation axis of said first feeding screw and a rotation axis of said second feeding screw with respect to a direction perpendicular to the rotational axis direction.

14. An apparatus according to claim 13, wherein said toner content sensor has a detection surface disposed at a bottom surface of said first communicating portion in a region which is in said first communicating portion with respect to the rotational axis direction of said developer carrying member and which is between the rotation axis of said first feeding screw and the rotation axis of said second feeding screw.

15. An apparatus according to claim 13, wherein with respect to a vertical direction, a bottom surface of said second chamber opposed to said second feeding screw is at a higher level than a bottom surface of said first chamber opposed to said first feeding screw.

16. An apparatus according to claim 13, wherein with respect to a vertical direction, said developer carrying member is disposed at a level higher than said first feeding screw.

17. An apparatus according to claim 13, wherein said toner content sensor is disposed in a first feeding screw side of a central position of a distance between the rotational axis of said first feeding screw and the rotational axis of said second feeding screw.

18. An apparatus according to claim 15, wherein a bottom surface of said first communicating portion is inclined relative to a horizontal direction, and the detection surface of said toner content sensor is disposed along the inclined surface.

19. An apparatus according to claim 13, wherein said detecting portion is projected beyond the bottom surface by an amount not more than 1 mm.

20. An apparatus according to claim 18, wherein the inclined surface is inclined relative to the horizontal direction by not more than 45°.

21. An apparatus according to claim 13, wherein said first fitting screw and said second fitting screw are disposed at respective phases which are different from each other by not less than 30°.

22. An apparatus according to claim 21, wherein said first feeding screw and said second feeding screw are disposed with 180° deviation of the phase such that the edge portion of said second blade most remote from said partition when the edge portion of said first blade is closest to said partition during the rotation.

23. An apparatus according to claim 13, wherein said second feeding screw feeds the developer to a neighborhood of said second communicating portion in a direction opposite to the second direction.
